(19) United States
(12) Patent Application Publication
(10) Pub. No.: US 2003/0182342 A1
(43) Pub. Date: Sep. 25, 2003

(54) Low-cost multiplication in small DFT butterflies

(76) Inventor: Charles Douglas Murphy, Chicago, IL (US)

Correspondence Address: CHARLES DOUGLAS MURPHY, 601 LINDEN PLACE #210, EVANSTON, IL, 60202, US

(21) Appl. No.: 10/104,534

(22) Filed: Mar. 25, 2002

(51) Int. Cl. G06F 7/52; G06F 17/14

(52) U.S. Cl. 708/620; 708/403

(57) ABSTRACT

A machine used for multiplication which exploits the facts that cos(2π/3) is equal to minus one half and that the sum of cos(−2π/5) and cos(−4π/5) is also equal to minus one half. Low-cost multiplication by cos(2π/3) can be implemented with simple negation and shifting operations in three-point discrete Fourier transforms (DFTs) and in related three-point transforms. Low-cost multiplication of a multiplier input by both cos(−2π/5) and cos(−4π/5) can be implemented with a first multiplication of the multiplier input by one of the numbers to produce a first product, simple negation and shifting operations to obtain an intermediate result which is minus one half times the multiplier input, and subtraction of the first product from the intermediate result to obtain the second product. The invention is particularly intended for implementation in technologies where general multiplication operations are expensive, such as field-programmable gate arrays or application-specific integrated circuits. In one embodiment, a circuit implementing multiplication by minus one half can be used for computing products in both three-point transforms and five-point transforms. In other embodiments, the invention can be used in computing DFTs and related transforms having composite size larger than three but with factors of three or five.

### CROSS-REFERENCE TO RELATED APPLICATIONS

The invention is related to SHARED MULTIPLICATION IN SIGNAL PROCESSING TRANSFORMS submitted as a separate application to the US PTO by Charles D. Murphy and having application Ser. No. 09/976,920 and filing date Oct. 15, 2001.

### STATEMENT REGARDING FEDERALLY SPONSORED RESEARCH OR DEVELOPMENT

Not applicable

### REFERENCE TO A MICROFICHE APPENDIX

Not applicable

### BACKGROUND

1. Field of Invention

The invention relates to the computation of multiple products in small butterflies of discrete Fourier transforms and related transforms using shared multiplication results.

2. Description of Prior Art

The present invention is a specialized case of the invention proposed by the applicant in SHARED MULTIPLICATION IN SIGNAL PROCESSING TRANSFORMS, which was submitted as a separate application to the US PTO by Charles D. Murphy. The invention of that application was a multiplier which computed two or more products, with intermediate terms and possibly the final result of computing one product also used in computing other products. The invention enabled cost reduction by elimination of redundant calculations.

In particular, the prior art application envisioned exploiting the common properties of representations of number values in given finite-precision numeric formats, such as common bit patterns in the representations. Common bit patterns may not be apparent from consideration of base-10 number representations. The present invention exploits some interesting properties of number values in both binary and base-10 formats.

Other relevant prior art includes a vast array of reduced-complexity techniques for computing discrete Fourier transforms (DFTs) and related transforms and recently suggestions of constant multipliers for such transforms. However, prior art fast Fourier transform techniques and constant multipliers have not exploited the coincidental number value properties on which the present invention is based.

### SUMMARY

The present invention is a technique for low-cost product computation in the DFT and related transforms. One or more coefficients in the transforms may have values or relative values that permit either low-cost non-shared multiplication or low-cost shared multiplication for some finite-precision numeric formats.

### OBJECTS AND OBJECTIVES

There are several objects and objectives of the present invention.

It is an object of the present invention to provide a three-point DFT technique which has lower implementation cost than prior art three-point DFT techniques.

It is an object of the present invention to provide a five-point DFT technique which has lower implementation cost that prior art five-point DFT techniques.

It is a further object to enable reduced-cost three-point transform techniques for inverse DFTs, for discrete and inverse discrete cosine transforms, for discrete and inverse discrete sine transforms, and for other transforms.

It is a further object to enable reduced-cost five-point transform techniques for inverse DFTs, for discrete and inverse discrete cosine transforms, for discrete and inverse discrete sine transforms, and for other transforms.

It is an object of the present invention to reduce the implementation cost of fast Fourier transform techniques applied to transforms with large sizes that have factors which are non-zero powers of three, non-zero powers of five, or both.

It is still another object of the present invention to provide a multiplier which can be used in both computation of three-point transforms and computation of five-point transforms.

Further objects and advantages of the invention will become apparent from a consideration of the ensuing description.

### DRAWING FIGURES

Not applicable

### REFERENCE NUMERALS IN DRAWINGS

Not applicable

### DESCRIPTION

### Discrete Fourier and Inverse Fourier Transforms

The formulae for an N-point discrete Fourier transform (DFT) and for an N-point inverse DFT are given by equations (1) and (2) respectively.

X[k]=Σ_{n=0 to N-1}x[n]exp({j2πnk/N}) for k=0 to N−1 (1)

x[n]=(1/N)Σ_{k=0 to N-1}X[k]exp({jπ2nk/N}) for n=0 to N−1 (2)

Equations (1) and (2) are closed-form representations of an N-point DFT and an N-point inverse DFT that suggest direct computation of each of the N outputs as the sum of N complex-weighted complex inputs. The operational cost of using direct computation is approximately N² complex additions and approximately N² complex multiplications. Clearly, as N gets large, the operational cost can become excessive.

During the past 35 years or more, researchers have investigated fast Fourier transform (FFT) techniques which have a much lower operational cost. Typically, FFT techniques can achieve operational costs on the order of N log₂ N, written O(N log₂ N), complex multiplications and O(N log₂ N) complex additions. The value N log₂ N increases much more slowly with increasing N than does the value N².

FFT algorithms typically function by dividing a DFT or inverse DFT computation of large size into repeated DFT or inverse DFT computations of small size. If the smaller size can itself be factored, then the process can be recursive. For instance, a 128-point DFT can be computed with four 32-point DFT computations, followed by twiddle factor multiplications, followed by thirty-two 4-point DFT computations. Since 32 can be factored into the product of 8 and 4, each of the 32-point DFT computations is amenable to further decomposition.

Part of the cost savings of FFT algorithms arises from the fact that highly-composite N values can be factored into products of small factors for which there are extremely low-cost FFT structures. Sometimes the structures are known as “butterflies” on account of their appearance in standard diagrams. Examples of low-cost butterflies include 2-point butterflies, 4-point butterflies, and 8-point butterflies. The weights in 2-point butterflies are +1 and −1, so they require no multiplication operations. The weights in 4-point butterflies are +1, +j, −1, and −j, so 4-point butterflies also require no multiplication operations. Multiplication can be implemented with addition and subtraction of appropriate real and imaginary components of butterfly input numbers. Similarly, 8-point butterflies can exploit the fact that the real and imaginary components of the weights exp({jπ/4}), exp({j3π/4}), exp({j5π/4}), and exp({j7π/4}) have the same magnitude and that the weights +1, +j, −1, and −j require no multiplications.

Since the DFT and the inverse DFT are used extensively and repeatedly in many signal processing applications, often with real-time computation, constant multipliers have been proposed as a replacement for general multipliers. Whereas a general multiplier must be able to compute the product of two numbers which can take on any values supported by their respective finite-precision numeric formats, a constant multiplier need only be able to compute the product of a constant and one number which can take on any value supported by its finite-precision numeric format. Constant multipliers may have much lower cost than general multipliers, where the cost is measured by required space on an integrated circuit, power consumption, or other factors. However, the cost savings come at the expense of flexibility.

Another recent proposal for reducing the cost of computing signal processing transforms is shared computation. In shared computation, basic associative and distributive properties of arithmetic are exploited so that in the course of computing one product, intermediate terms are generated that can be used to compute a second product. The savings stem from not repeating operations that occur in both product computations.

FFT techniques comprising layers of small-size butterflies are a clear case of shared computation based on associative and distributive properties of the number values of the transform weights. However, they do not include shared computation based on special structures of the number representations of the number values in given finite-precision numeric formats. Several finite-precision numeric formats have interesting properties that are exploited by the present invention.

### Signed and Two's Complement Representations

Even though human beings often use a decimal number system in which the representation elements are 10 possible digits, in computing devices the prevalent representation element is the bit, which has 2 possible values.

An important class of binary number systems consists of number systems which can represent both positive numbers and negative numbers. Two such systems are sign magnitude representations and two's complement representations.

In sign magnitude representations, one bit represents the sign of a number, and the remaining bits represent the magnitude of a number. The remaining bits usually include a most-significant bit (MSB) representing a particular number value, a bit representing half of the MSB's number value, a bit representing one quarter of the MSB's number value, and so on, until a least-significant bit (LSB) is reached.

Sign magnitude representations are often used in analog-to-digital converters. Important features of sign magnitude representations from a computational perspective are that negation—that is, multiplication by minus one—can be implemented by changing the state of the sign bit, while scaling by powers of two can be implemented via wholesale shifting of the magnitude bits.

The dominant signed representation in digital computing is two's complement. According to p. 477 of the second edition of “The Art of Electronics” by Paul Horowitz and Winfield Hill:

In this system, positive numbers are represented as simple unsigned binary. The system is rigged up so that a negative number is then simply represented as the binary number you add to a positive number of the same magnitude to get zero. To form a negative number, first complement each of the bits of the positive number (i.e., write 1 for 0, and vice versa; this is called the “1's complement”), then add 1 (that's the “2's complement”).

In two's complement representations, addition, subtraction, and multiplication operations work the same way regardless of the signs of the numbers, which is not the case for sign magnitude representations. The all-zero string represents the number value zero.

Referring again to computation, two's complement representations have a simple means for negation, namely bit flipping followed by addition of the two's complement representation for the number one. Also, multiplication by powers of two can be implemented via shifting of groups of bits.

In addition to integer representations, there are floating point number representations in which some bits represent an exponent value and some bits represent a mantissa value. The mantissa and exponent taken separately may be represented in two's complement, as unsigned integers, or in another representation. Possible low-cost operations include negation and subtraction and multiplication of mantissa by mantissa or of exponent by exponent

### Special Features of Certain Weights

The DFT, the inverse DFT, and related transforms such as the discrete cosine transform typically have multiple outputs which are computed from multiple inputs. Each input may have different weights in different outputs.

In the present invention, three weight components are considered. These are shown in equations (3), (4), and (5) below. In each case, a signed decimal representation of the weight is shown to 14 decimal places.

| | |
|---|---|
| (3) cos( −2π/ 3) = | −0.50000000000000 |
| (4) cos( −2π/ 5) = | 0.30901699437495 |
| (5) cos( −4π/ 5) = | −0.80901699437495 |

Note that cos(A)=cos(−A). With respect to DFT and inverse DFT computation, cos(−2π/3) is a weight component for complex weights in a 3-point transform. By extension, it can also be a multiplication coefficient component in an FFT decomposition for any N value which has 3 as a factor. With respect to DFT and inverse DFT computation, cos(−2π/5) and cos(−4π/5) are weight components of complex weights for a 5-point transform. By extension, they can also be used as multiplication coefficient components in an FFT decomposition for any N value which has 5 as a factor.

In an FFT structure using 3-point butterflies, equation (3) and the special properties of finite-precision numeric formats such as the two's complement representation mean that the operation of multiplication by cos(−2π/3) can be implemented with a negation operation and a shifting operation. In a specialized hardware implementation, the shifting operation can be implemented by a hard-wired connection of one register's bit latches to bit latches corresponding to the shift in another register. Thus, only a negation operation may need to be performed.

The following special relationship holds between equations (4) and (5).

cos(−2π/5)+cos(−4π/5)=−0.50000000000 (6)

In other words, the sum of these two coefficients of a 5-point DFT or inverse DFT butterfly is equal to a number by which multiplication may only require negation and shifting, or, for specialized hardware implementations, only negation.

Equation (6) suggests two possible techniques for computing the product of a number β and both cos(−2π/5) and cos(−4π/5). In one technique, a first result which is the product β cos(−2π/5) could be computed by a general multiplier or by a constant multiplier. Simple negation and shifting operations could be used to compute a second result which is −0.5 β. Finally, the first result could be subtracted from the second result to obtain β cos(−4π/5). In the other method, the product β cos(−4π/5) is computed by a general multiplier or by a constant multiplier, and subtracted from −0.5 β to obtain β cos(−2π/5).

Note that since cos(−2π/5) is equal to cos(2π/5), is equal to the negative of cos(−3π/5), and is equal to the negative of cos(3π/5), various addition, subtraction, and negation operations can be used to achieve the same result of shared computation. Also, since cos(−2π/3) is equal to cos(2π/3), is equal to the negative of cos(π/3), and is equal to the negative of cos(π/3), shifting, negation, and addition, shifting and subtraction, or just shifting may be used for low-cost product computation.

Using the negate-and-shift technique for computing the products of cos(2π/3) and cos(2π/3), the number of costly real multiplications required to compute a full 3-point DFT drops from 4 to 2. Similarly, using the shared computation technique for computing products of cos(−2π/5), cos (−4π/5), cos(2π/5), and cos(4π/5) in a 5-point DFT reduces the minimum number of costly real multiplications required from 16 to 12.

While a savings of 2 real multiplication operations for a 3-point butterfly and a savings of 4 real multiplications for a 5-point butterfly do not seem particularly great, the savings can become quite large when the 3-point and 5-point butterflies are repeated numerous times during computation of a much larger transform. Even though, for example, a 3-point butterfly has a greater multiplication cost than a 4-point butterfly, a transform of size 2^{m} times 3 may have a lower multiplication cost than a transform of size 2^{m+2}. This is because FFT techniques that factor a large composite N into factors which are not relatively prime—such as 2^{m} and 4—require multiplication by so-called twiddle factors. Twiddle factors are not required between factors that are relatively prime, such as 2^{m} and 3. Also, there are only three-quarters as many inputs and outputs for a size 2^{m} times 3 transform as for a size 2^{m+2} transform.

### The Preferred Embodiment of the Invention

The preferred embodiment of the invention is a machine used for multiplication, comprising a first input number in a finite-precision numeric format for which negation is a low-cost operation and for which multiplication by a power of two is a low-cost operation which can be implemented by shifting a group of bits in a number representation. The preferred embodiment comprises a first weight substantially equal to either cos(2π/3) or to cos(7π/3), namely, either minus one half or plus one half respectively. The preferred embodiment also comprises means for computing a first product equal to the product of the first input and the first weight. The computing means substantially comprises a shifting operation and, in the case of the weight being equal to cos(2π/3), a negation operation.

In allowing the weight to be substantially equal to plus one half or minus one half, the preferred embodiment recognizes that in a finite-precision numeric format with high precision, there may be many number value representations not exactly equal to plus one half or minus one half that are nonetheless almost equal. It is desired that the preferred embodiment of the invention cover multiplication machines that use such weights, such as a multiplying machine that multiplies a first input number by one half plus 2^{-m} for large m.

### Alternative Embodiments

In an alternative embodiment of the invention, the multiplying machine of the preferred embodiment is used for computing a three-point transform such as a three-point DFT, a three-point inverse DFT, a three-point discrete cosine transform, a three-point inverse discrete cosine transform, or other three-point transforms.

In another alternative embodiment of the invention, the multiplying machine is used in computing a three-point transform which is itself used in computing a transform with size larger than three. Particularly, this embodiment is intended to cover FFT techniques in which a highly-composite transform size N is computed via factoring into repeated smaller-sized transforms, in which one of the factors is three and in which the decomposition to smaller-sized transforms is applied recursively to obtain a structure using 3-point butterflies.

In another alternative embodiment, the multiplying machine is used to compute transforms of size larger than three without necessarily computing a transform of size three. For instance, one might compute a DFT of size six directly or with some decomposition other than into two three-point DFTs and three two-point DFTs.

In the claims, discrete and inverse discrete Fourier transforms, discrete and inverse discrete cosine transforms, and discrete and inverse discrete sine transforms are proposed as candidates for the use of the machine. There are in fact several variants of these transforms, including multi-dimensional versions and versions with weight offsets (e.g. the various types of discrete cosine and sine transforms), and partial transforms in which some inputs or outputs are equal to zero or are otherwise not of interest. The listed transforms and their variants are widely used in many applications such as speech processing, digital communications, radar, sonar, seismic signal processing, and image processing, to name a few. It is intended that the claims cover use of the present invention in the transforms listed in the claims, as well as use in the variants, and also in any novel transforms that are substantially based on the listed transforms or variants.

In still another alternative embodiment, the multiplying machine computes products in which the first weight is in fact scaled by a first scaling factor for which there are low-cost multiplication techniques. For instance, the scaling factor might be the number 3. A low-cost alternative to multiplying a number by 3 is to add the number to itself twice. The alternative embodiment of the invention with the scaled first weight is intended to cover transforms in which additional low-cost multiplications are included in transforms in order to avoid the language of the claims regarding substantial equality to sets of numbers. Other low-cost multiplication techniques can be used in conjunction with the present invention.

For instance, in the inverse DFT of size three, there is a scaling factor of one third. Ordinarily, this is applied to inputs before or to outputs after stages that compute products of numbers and unit-amplitude complex weights. As another example, one might arbitrarily scale all the weights by two, and include low-cost scaling by one half of either inputs or outputs. Both cases and similar cases should be recognized as embodiments of the present invention.

In still another alternative embodiment, a shifting operation used in computing the first product can be implemented by hard-wired connection. For instance, bits being transferred from one storage register to another storage register can pass along wires that directly connect each bit storage element in the first storage register to a shifted counterpart in the second storage register. Alternatively, inputs to or outputs from a computational circuit can be passed along wires that implement the shift. The result of implementing the shift with a hard-wired connection is that the cost of the shift operation may be effectively zero.

### Alternative Embodiments With Shared Multiplication

An alternative embodiment of the invention which uses shared multiplication techniques comprises a first input number represented in a first finite-precision numeric format which enables low-cost negation and multiplication by a power of two using shifting. The alternative embodiment includes a first weight substantially equal to a member of the set consisting of cos(−2π/5) and cos(−3π/5), and a second weight substantially equal to a member of the set consisting of cos(−4π/5) and cos(−7π/5). The alternative embodiment computes a first product which is the product of a first input number and either the first weight or the second weight, and computes a second product which is the product of the first input number and the other weight using the first product.

The purpose of substantial equality is again to provide coverage in the case of high-precision numeric formats with weights not quite equal to cos(−2π/5), cos(−3π/5), cos(−4π/5), or cos(−π/5). Multiplying a number by a two weights that are substantially equal can provide substantially equivalent computational results, both in terms of the number values of the calculated products and in terms of the cost of calculation.

In other alternative embodiments, the shared multiplying machine uses the low-cost operations of negation and multiplication through shifting applied to the first product to produce the second product. For two's complement number representations, it seems to be most efficient to compute, for instance, β cos(−2π/5) and β/2, then to add β cos(−2π/5) to β/2, and then to negate the sum to obtain β cos(−4π/5).

In another alternative embodiment, the shared multiplication machine can be used for computing five-point DFTs, five-point inverse DFTs, five-point discrete and inverse discrete cosine transforms, and five-point discrete and inverse cosine transforms. In still another alternative embodiment, the shared multiplying machine can be used in five-point butterflies which are in turn used to compute transforms of larger size. Alternatively, the shared multiplying machine can be used in structures other than five-point butterflies which are used to compute transforms of size larger than five.

In another alternative embodiment, the shared multiplication machine can be used with both the first weight and the second weight scaled by a common first scaling factor for which there exist low-cost multiplication techniques. As in the case of the corresponding embodiment with the non-shared multiplying machine, this alternative embodiment is intended to cover transforms in which additional low-cost multiplication operations are included in transforms in order to avoid the language of claims on other embodiments.

In still another alternative embodiment, the shared computation can use a shifting operation implemented by hard-wired connection. This may result in a zero-cost multiplication operation in such technologies as field-programmable gate arrays and application-specific integrated circuits. In another alternative embodiment intended particularly for these technologies, a non-general multiplication machine which implements the first multiplication by cos(2π/3) or by cos(π/3) can also be used in the shared multiplication operations. This multiplication machine can be used to compute three-point transforms, to compute five-point transforms, or to compute larger transforms with sizes that have three, five, or three and five as factors. In an alternative embodiment, the non-general multiplication machine can be a constant multiplier, which may be implemented efficiently in a field-programmable gate array or on an application-specific integrated circuit. The circuit can be used repeatedly for various transform sizes.

### CONCLUSION, RAMIFICATIONS, AND SCOPE

The reader will see that the present invention has several advantages over prior art techniques for computing products in discrete Fourier transforms, inverse discrete Fourier transforms, discrete cosine transforms, inverse discrete cosine transforms, and other related transforms.

The description above contains many specific details relating to composite transform sizes, DFT and inverse DFT computation, FFT techniques, finite-precision numeric formats, implementation technologies, complexity, relative computational cost, and applications. These should not be construed as limiting the scope of the present invention, but as illustrating some of the presently preferred embodiments of the invention. The scope of the invention should be determined by the appended claims and their legal equivalents, rather than by the examples given.

I claim:

1. A machine used for multiplication, comprising:
a. a first input number represented in a finite-precision numeric format in which:
i. negation is a low-cost operation
ii. multiplication by a power of two is a low-cost operation which can be implemented substantially by shifting a group of bits in a number representation
b. a first weight substantially equal to a member of the set consisting of cos(2π/3)and cos(π/3)
c. means for computing a first product equal to the product of said first input and said first weight, said first means substantially comprising:
i. a negation operation, if said first weight is substantially equal to cos(2π/3)
ii. a shifting operation
whereby said first product may be computed with low-cost operations rather than with an expensive multiplication operation.

2. The machine of claim 1 used for computing a three-point transform which is a member of the set of transforms consisting of three-point discrete Fourier transforms, three-point inverse discrete Fourier transforms, three-point discrete cosine transforms, three-point inverse discrete cosine transforms, three-point discrete sine transforms, and three-point inverse discrete sine transforms.

3. The machine of claim 2 in which said three-point transform is used for computing a transform of size larger than three which is a member of the set of transforms consisting of discrete Fourier transforms of size larger than three, inverse discrete Fourier transforms of size larger than three, discrete cosine transforms of size larger than three, inverse discrete cosine transforms of size larger than three, sine transforms of size larger than three, and inverse sine transforms of size larger than three.

4. The machine of claim 1 used for computing a transform of size greater than three which is a member of the set of transforms consisting of discrete Fourier transforms of size greater than three, inverse discrete Fourier transforms of size greater than three, discrete cosine transforms of size greater than three, inverse discrete cosine transforms of size greater than three, discrete sine transforms of size greater than three, and inverse discrete sine transforms of size greater than three.

5. The machine of claim 1 in which:
a. said first weight is scaled by a first scaling factor
b. said first scaling factor permits low-cost multiplication of a number by said first scaling factor, for instance, low-cost multiplication implemented with a small number of shifting, negation, and addition operations
c. said first product is the product of said first input number, said first weight, and said first scaling factor
whereby a scaled version of the product of said first input number and said first weight can be computed using low-cost operations rather than an expensive multiplication operation.

6. The machine of claim 1 in which said shifting operation of said means for computing said first product is implemented by hard-wired connection, for instance, by hard-wired connection of bit storage elements in a first digital register to the corresponding shifted bit storage elements in a second digital register, whereby said shifting operation can have no cost in a dedicated computing circuit.

7. A machine used for multiplication, comprising:
a. a first input number represented in a finite-precision numeric format in which:
i. negation is a low-cost operation
ii. multiplication by a power of two is a low-cost operation which can be implemented substantially by shifting a group of bits in a number representation
b. a first weight substantially equal to a member of the set consisting of cos(−2π/5) and cos(−3π/5)
c. a second weight substantially equal to a member of the set consisting of cos(−4π/5) and cos(−π/5)
d. means for computing a first product equal to the product of said first input number and one member of a first weight set consisting of said first weight and said second weight
e. means for computing a second product equal to the product of said first input number and the other member of said first weight set using said first product
whereby said first product may be used for low-cost computation of said second product.

8. The machine of claim 7 in which said means for computing said second product using said first product comprises:
a. means for computing a first intermediate product equal to the product of said first input number and a third weight substantially equal to minus one half, said means comprising a negation operation and a shifting operation
b. means for subtracting said first product from said first intermediate product to produce said second product whereby computing said second product requires one shifting operation, one negation operation, and one subtraction operation.

9. The machine of claim 7 in which said means for computing said second product using said first product comprises:
a. a shifting operation for computing a first intermediate product equal to the product of said first input number and a third weight substantially equal to plus one half
b. means for adding said first product to said first intermediate product to produce a second intermediate product
c. means for negating said second intermediate product to produce said second product
whereby computing said second product requires one shifting operation, one addition operation, and one negation operation.

10. The machine of claim 7 used for computing a five-point transform which is a member of the set of transforms consisting of five-point discrete Fourier transforms, five-point inverse discrete Fourier transforms, five-point discrete cosine transforms, five-point inverse discrete cosine transforms, five-point discrete sine transforms, and five-point inverse discrete sine transforms.

11. The machine of claim 10 in which said five-point transform is used for computing a transform of size larger than five which is a member of the set of transforms consisting of discrete Fourier transforms of size larger than five, inverse discrete Fourier transforms of size larger than five, discrete cosine transforms of size larger than five, inverse discrete cosine transforms of size larger than five, sine transforms of size larger than five, and inverse sine transforms of size larger than five.

12. The machine of claim 7 used for computing a transform of size greater than five which is a member of the set of transforms consisting of discrete Fourier transforms of size greater than five, inverse discrete Fourier transforms of size greater than five, discrete cosine transforms of size greater than five, inverse discrete cosine transforms of size greater than five, discrete sine transforms of size greater than five, and inverse discrete sine transforms of size greater than five.

13. The machine of claim 7 in which:
a. said first weight is scaled by a first scaling factor
b. said second weight is scaled by said first scaling factor
c. said first scaling factor permits low-cost multiplication of a number by said first scaling factor, for instance, low-cost multiplication implemented with a small number of shifting, negation, and addition operations
d. said first product is the product of said first input number, said first weight, and said first scaling factor
e. said second product is the product of said second input number, said second weight, and said first scaling factor
whereby a scaled version of the product of said first input number and said first weight and a scaled version of the product of said first input number and said second weight can be computed using low-cost operations and a shared result rather than using two separate expensive multiplication operations.

14. The machine of claim 7 in which:
a. said means for computing said first product using said second product comprises shifting means
b. said shifting means is implemented by hard-wired connection, for instance, by hard-wired connection of bit storage elements in a first digital register to the corresponding shifted bit storage elements in a second digital register
whereby said shifting means can have no cost in a dedicated computing circuit.

15. A machine used for multiplication:
a. which can be used to compute the product of a first input number and a weight substantially equal to a member of the set consisting of cos(−2π/3) and cos(−π/3)
b. which is not a general multiplier capable of computing the product of a first input number which can take on any value allowed by its finite-precision numeric format and a second input number which can take on any of a multiplicity of values allowed by its finite-precision numeric format
c. which can be used to compute a first transform of size three which is a member of the set of transforms consisting of discrete Fourier transforms of size three, inverse discrete Fourier transforms of size three, discrete cosine transforms of size three, inverse discrete cosine transforms of size three, sine transforms of size three, and inverse sine transforms of size three
d. which can be used to compute a first transform of size five which is a member of the set of transforms consisting of discrete Fourier transforms of size five, inverse discrete Fourier transforms of size five, discrete cosine transforms of size five, inverse discrete cosine transforms of size five, sine transforms of size five, and inverse sine transforms of size five
whereby said machine can be used for computing said first transform of size three and for computing said first transform of size five, whereby said machine can be re-used in computing transforms of size three or greater in which three, five, or three and five are factors.

16. The machine of claim 15 which is a constant multiplier.

17. The constant multiplier of claim 16 which is used:
a. to compute the product of a first input number and a first weight coefficient substantially equal to a member of the set consisting of cos(−2π/3) and cos(−π/3) in three-point transforms
b. to compute the product of a second input number and a weight substantially equal to a member of the set consisting of said first weight coefficient and the negative of said first weight coefficient in five-point transforms
whereby said constant multiplier can be re-used in computing transforms with sizes that have factors three, five, or factors three and five.
